(19) United States
(12) Patent Application Publication
(10) Pub. No.: US 2008/0128070 A1
(43) Pub. Date: Jun. 5, 2008

(54) Fire-Resistant Drywall Tape, Method Of Using And Manufacture of the Same

(75) Inventor: Lee Goldman, Millburn, NJ (US)

Correspondence Address: SILLS CUMMIS EPSTEIN & GROSS P.C., ONE RIVERFRONT PLAZA, IP DEPARTMENT, NEWARK, NJ, 07102, US

(73) Assignee: Dura-Tape International, Bloomfield, NJ (US)

(21) Appl. No.: 11/942,519

(22) Filed: Nov. 19, 2007

Related U.S. Application Data
(63) Continuation-in-part of application No. 11/129,642, filed on May 16, 2005.

(51) Int. Cl. E04F 13/00; B32B 7/12; B05D 5/10

(52) U.S. Cl. 156/71; 428/343; 427/207.1

(57) ABSTRACT

The present invention relates to a fire-resistant wallboard tape. The fire-resistant wallboard tape covers elongated joints in wallboards. This tape includes a fluid-activated, gummed adhesive, a fibrous material and a flame retardant additive. The fluid-activated, gummed adhesive is adhered to a surface of the fibrous material and is activated when wet. And since the fibrous material is a resin-impregnated body, the fibrous material will remain relatively non-moisture absorbent during activation of the fluid-activated, gummed adhesive, thereby allowing the fluid-activated, gummed adhesive to dry within several minutes after activation. This, in combination with, the flame retardant additive allows the fire-resistant wallboard tape to achieve quick drying times and at least a one-hour fire rating.

### CROSS REFERENCE TO RELATED APPLICATIONS

This application is a continuation-in-part of co-pending application Ser. No. 11/129,642 entitled “Wallboard tape and method of using same,” filed May 16, 2005.

### BACKGROUND OF THE INVENTION

1. Field of the Invention

The present invention relates to flame resistant wallboard paper. Specifically, the present invention relates to a flame-resistant, resin-impregnated drywall tape that uses a water-activated, gummed adhesive to shorten drying times.

2. Prior Art

In the building and construction trade there are standard established procedures for securing wallboards to a building frame. But no matter the procedure, once hung, the adjoining wallboards have exposed elongate joints that need to be covered.

In order to cover these joints, a layer of joint compound, called a bedding layer, is applied (mud or plaster) in the joint itself and a segment of joint tape running the length of the wallboard joint is embedded within the compound. The compound is then given time to dry before any work may be done on the wallboards.

Depending upon the ambient atmosphere, the aeration time is approximately 18 to 24 hours. The drying is a critical factor so that the joint environment is free of moisture. Moisture breeds mold and mildew that can spread throughout the wallboard perpetuating building decay and promoting a health hazard.

After the drying is complete and sanding takes place, a second coat of compound is applied over the tape so as to hide the tape from view. This second application requires a second drying period of about 12 hours. These two drying times are required, regardless of the basic components (animal, starch, or polyvinyl acetate) found in the majority of compounds used. After the second application is dry, the area is smooth sanded and the surface is now ready for painting or any other process that is deemed necessary for the project.

This established procedure is easily executed by trained professionals but a novice would have a difficult time achieving a perfect seam with only two coats. Therefore, additional coats and drying times may be needed.

In addition, the generally accepted conventional joint tape calls for 80-100 pound Kraft paper with 0-2% wet strength properties. These tapes are formulated from pulp becoming Kraft paper as the finished product. Specifications of Kraft paper used require set standards of high tensile fiber composition with wet, dry and cross tear strengths as the standard determined properties (ASTM-475). This Kraft paper is absorbent and allows the penetration of the compound within the paper. This absorption increases the amount of time needed for the compound to dry.

Kraft paper is either manufactured as a spark-perforated surface or a plain gypsum ribbon. Both paper types are typically sanded creating a fine nap for greater adhesion qualities. These tapes include a defined center margin for an accurate taping guide, particularly for corners. The benefits of spark-perforation are for a faster and even drying outcome.

A fiberglass mesh tape may be used as a joint seam. These fiberglass tapes are available in either a self-adhesive roll (one side adhesively coated) or a plain, non-adhesive staple roll, depending upon the user's preference. The benefit of this tape is a grid fabrication that interlocks with the bedding layer of compound. The general practice allows for the mesh as a first stage of application, and then follows the same procedures including the two coats of compound that require extensive drying time as described above. The fiberglass mesh tape is more expensive than conventional paper tape, thus being used more often for repairs than for wallboard joint connection. It is also more difficult to hide the tape from view when applying the second layer of compound and a third layer of compound is usually used.

Furthermore, in construction, during drywall installation, certain demising walls such as in homes with an adjoining garage or a commercial space that abuts another need to be fire-taped. This process is meant to slow the spread of fire from one area to another and is not different than the process of joining wallboard sections using joint compound and tape with the exception that once the tape is imbedded in compound, no additional compound is required to cover the tape. This tape once applied requires 18-24 hours to dry. The result is a sealed joint disallowing air movement, thus starving any flame of needed oxygen.

In the building trade there are fiberglass reinforced self-adhesive paper tapes that offer fire resistance. But these tapes are not conducive to a typical work environment because most drywall installations create a dusty environment. And when the self-adhesive paper tapes are used in this situation, the tape will have a weak bond with its application surface and oftentimes delaminate. These tapes also require a special notched trowel to apply the self-adhesive paper tape that adds to the cost of the application. And the self-adhesive paper tape has a layer of release paper that off-rolls during the application process. This paper accumulates on the floor and quickly becomes an entanglement hazard for workers.

There is significant commercial interest in the fabrication of fire tape that is easy to install, is cost efficient and has a short drying time. Therefore further improved compositions and methods are needed to enhance the construction trade.

### SUMMARY OF THE INVENTION

This invention relates generally to the construction and building trade, and more particularly to an improved unique version of paper fiber type joint tape usually available in roll form. The objective of wallboard tape is to join gypsum drywall segments to conceal the fusion in a smooth seamless transition from section to section.

The present invention enhances the characteristics of paper fiber joint tape by providing a fire-resistant wallboard tape that covers elongated joints in wallboards. The fire-resistant wallboard tape includes a fluid-activated adhesive that is gummed to a fibrous material having a non-moisture absorbent, resin-impregnated body. The fluid-activated, gummed adhesive is applied to a top surface of the fibrous material while the bottom surface of the fibrous material is used for applying the tape to elongated joints of adjoining wallboards.

The fluid-activated, gummed adhesive may be a water-soluble, water-activated adhesive and during activation of the adhesive the fluid-activated, gummed adhesive is submerged into a container of water. After the tape is removed from the water, the fibrous material remains relatively dry due to its non-moisture absorbency. That is, once the fluid-activated, gummed adhesive is activated the fibrous material remains relatively moisture free allowing the fluid-activated, gummed adhesive to dry in about 5 to 60 minutes. As stated above, the fluid-activated, gummed adhesive may be activated prior to installation over an elongated joint or activated by wetting surfaces adjacent to an elongated joint.

Additionally, a flame retardant additive is used in conjunction with the tape. With the air-tight bond preventing the flow of oxygen, the flame retardant additive insures the fire-resistant wallboard tape to achieve at least a one-hour fire rating.

A surface-sizing agent may also be added to the adhesive. Without a surface-sizing agent, after installation if the tape is rewetted, the tape may be reactivated and may shift on the wall. But adding the surface-sizing agent prevents an installed tape from being re-activated.

A color additive may be added to the adhesive or the paper. This is done to readily identify specialized tape in areas requiring the properties of such materials. It also allows building inspectors to easily identify specific concerns and the remedied materials.

Mold and mildew inhibitors may be added to the adhesive. The mold and mildew inhibitors include a liquid polysiloxane and the liquid polysiloxane is mixed with the fluid-activated, gummed adhesive in a proportion of less than five percent by volume.

The method of manufacturing a fire-resistant wallboard tape comprises the steps of providing a fluid-activated, gummed adhesive, providing a fibrous material having a resin-impregnated body that remains relatively non-moisture absorbent during activation of the fluid-activated, gummed adhesive and providing a specially designed formula of a fire retardant additive. The fibrous material is then coated or gummed with the fluid-activated, gummed material. The flame retardant additive may then be either added to the fibrous base or formulated with the adhesive. In either case, the flame retardant additive allows the fire-resistant wallboard tape to achieve at least a one-hour fire rating.

The method of using a fire-resistant wallboard tape to cover elongated joints in wallboards comprises the steps of providing an elongated length of fire-resistant wallboard tape of width sufficient to overlie the elongated joints. As stated above, the tape includes a resin impregnated fibrous base, a fluid-activated, gummed adhesive and a fire retardant additive. This tape, particularly, the fluid-activated, gummed adhesive is then wetted. This wetting process activates the fluid-activated, gummed adhesive while keeping the resin impregnated fibrous base relatively non-moisture absorbent. After the tape is wetted, the tape is then pressed into smooth contact with the wallboards to overlie the elongated joints and adhered to the wallboards. The fluid-activated, gummed adhesive is then allowed to dry by evaporation of moisture.

This invention is a quicker and more simplified method of taping wallboard joints formed by the abutting of adjacent wallboards, while also achieving a one-hour fire rating. The simple wetting of the tape activates the gummed adhesive and that is all that is necessary to complete the task. This accomplishment, without the use of joint compound, is completely dry in less than one hour. And not only will this invention arrest airflow as both required and described above, the actual paper substrate, contains fire retardant additives in its formulation to provide a one hour fire rating.

### BRIEF DESCRIPTION OF THE DRAWINGS

These and other features, aspects, and advantages of the apparatus and methods of the present invention will become better understood with regard to the following description and accompanying drawings where:

FIG. 1 is a side view of the wallboard tape of the present invention;

FIG. 2 is a bottom view of an alternate embodiment of the wallboard tape of the present invention.

### DETAILED DESCRIPTION OF THE INVENTION

The present invention enhances the characteristics of wallboard tape by providing a flame resistant wallboard paper that is water-activated and acts in accordance with fire code requirements. The common use for this tape is for vertical and horizontal joints of interior, above grid, non-load bearing walls needing at least a one-hour fire resistant.

The present invention utilizes fluids, such as water, to activate an adhesive that is applied, coated or gummed to a resin-impregnated tape body. The tape can be activated in dusty environments and there is no possibility of the tape delaminating. There is also no release paper attached to the body thus eliminating entanglement issues and disposal requirements. Additionally, there are no special tools required to apply the present invention which typically dries in about 5 to 60 minutes.

More specifically, the present invention uses a Kraft paper substrate that is impregnated with resin making the paper virtually non-absorbent. This paper is then treated with a fire retardant throughout and gummed with a water-activated adhesive. This combination allows the tape to be easily applied in the field. For application purposes, it is recommended that the tape be completely immersed in an activating fluid such as water so that the adhesive may be activated.

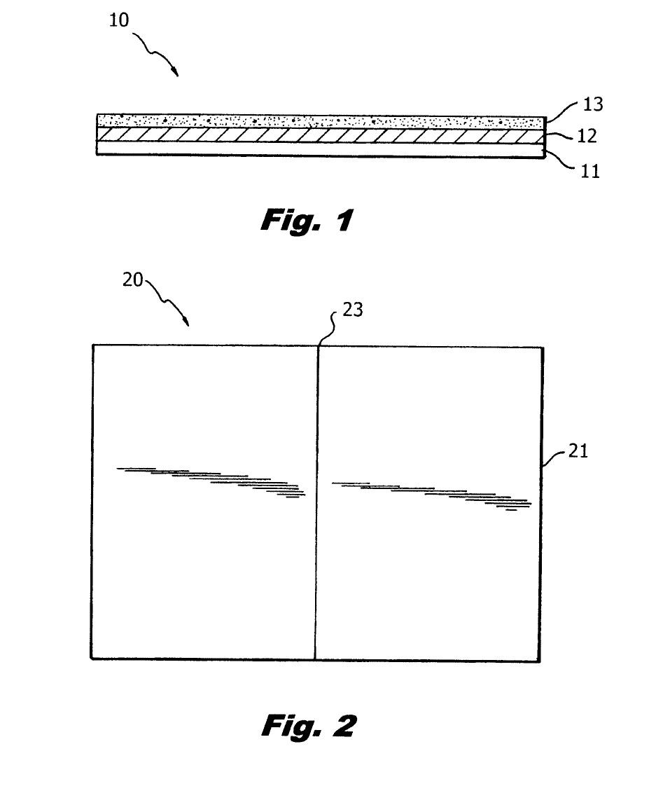

As shown in FIG. 1, the fire tape 10 is comprised of a first layer of fibrous material 11 and a fluid-activated adhesive layer 12 applied to one surface thereof. In the preferred embodiment the fluid-activated adhesive layer is water-soluble and water-activated adhesive.

An important feature to be noted is that within the adhesive formula there are provided certain additives to increase the functionality of the tape.

First and foremost there is a fire retardant additive 13 that is added during the manufacturing process. This additive 13 may be incorporated within the fibrous material, within the adhesive formulation or sprayed on after the adhesive is coated on the fibrous material. In FIG. 1 the fire retardant 13 was sprayed on top of the adhesive after the adhesive was coated/gummed on the fibrous material. But in any case, the fire retardant additive 13 enhances the tape by giving the tape at least one additional hour of fire resistance.

Moisture breeds mold and mildew that can spread throughout the wallboard perpetuating building decay and promoting a health hazard. Therefore, mold and mildew inhibitors may also be added to the tape to prevent bacterial growth. While a variety of such agents are commercially available, a preferred composition is sold under the trademark “Sil-75”, a liquid polysiloxane available from the Dow Chemical Corporation of Midland, Mich. This composition is preferably incorporated into the adhesive by mixing in a proportion of less than five percent by volume but a range of one to two percent by volume may be effective.

A surface-sizing agent may also be added to the adhesive. This agent when present prevents an installed and dried tape from being re-activated. That is, after the fire tape is applied to a joint and dried, rewetting the tape will not reactivate the adhesive.

A color additive may be added to the paper or the adhesive. The color added is for easily recognizing the fire tape product by those inspectors governing construction standards. The color additive may be added to the adhesive prior to being coated on the fibrous material but the color may also be sprayed onto the tape after the adhesive is gummed to the fibrous material.

As shown in FIG. 2, a preferred centerfold 23 may be employed to enable the tape 20 to be used with angle joints, as well as joints formed by inside corners of a wall. This centerfold 23, known in the art as a center margin, serves as a rule guide for the user.

As described above, the present invention uses a resin-impregnated fibrous wallboard tape which may be used without the necessity of first applying a bedding coat of compound or plaster. The merits of this are both economical and practical from the vantage point of the end user. To this end, the inner surface of the tape with the general basic conventional product qualities is coated with formulated water soluble, water-activated adhesive and other additives.

The tape 10 may be employed either by moistening the adhesive layer 12 using a wetted sponge (not shown), immersing the tape roll in a vessel of water, or a dispensing device that may or may not incorporate a wetted sponge. It is possible to wet the exposed surface of the wallboard adjacent to the joint so that moisture transfer from the wallboard wets the adhesive surface 12 of the tape 10 when applied. Preferably, a sponge brushing of the applied tape length across the joint takes place after application to ensure proper bonding wetness and a smooth drying result. During this period, or re-wetting later, the tape 10 may be accurately positioned if not originally properly aligned without difficulty.

The wetting is facilitated by the fact that the paper layer 11 which is resin impregnated does not absorb and retain substantial amounts of moisture, which also facilitates subsequent drying of the adhesive. As a result, the tape 10 is sufficiently dried and ready for the application of a finish coat of plaster compound after about 5 minutes to about one hour. In the preferred embodiment the tape dries after 30 minutes to an hour or in less than one hour depending on the humidity in which the tape is applied.

To activate the tape, a desired length of tape is unrolled from the fire tape roll. The desired length is the approximate amount of tape needed to fully cover an elongated joint of two adjacent wallboards. The tape remains inert until wetted and prior to installation the desired length is submerged into a container of water by either manually dipping the length into a bucket or utilizing a dispenser designed for this application.

Once activated, the tape is adhered to the joint. That is, the activated tape is installed over the abutted wallboard seams and is centered over the seam. The installer then wipes the tape firmly onto the seam with either his hand or a damp sponge. The tape cut is then cut to the exact length of the elongated joint by either simply tearing it by hand, by pulling it against the edge of a trowel or using a cutting device such as scissors.

It will be observed that since the adhesive layer is not activated prior to actual application to the joint, should any longitudinal twisting occur as the strip is handled, it can be readily straightened as the strip is applied without danger of the adhering layer adhering to itself, as is the case where pressure sensitive adhesives are employed.

The adhesive bonds as it aerates. Drying is quick as the tape properties allow moisture to evaporate rapidly. Substantial wetting of the paper tape is of little consequence to the bonding properties. Also, the absence of a bedding coat allows moisture to evaporate quickly from the underlying joint. Usually in less than one hour after beginning the process the final coat of either plaster or compound may be applied.

A major advantage of the present invention is in its ease of use. No special techniques or practices necessary to apply the product. A novice mechanic will be able to fire-tape a wall assembly with no specialized training or previous experience.

In order to manufacture the fire-resistant wallboard tape first the fluid-activated adhesive is gummed to the fibrous material. The adhesive layer 12 is preferably roll-coated using known techniques to conventional thickness. Since resin impregnated paper is mechanically stronger than Kraft paper, the fibrous material 11 may be of a lesser thickness than the conventional product.

A flame retardant additive is also added to the tape. The flame retardant additive allows the fire-resistant wallboard tape to achieve at least a one-hour fire rating.

The tape 10 may be conveniently packaged in roll form as known in the art. The tape 10 may be in a variety of widths, mostly ranging between one-eighth inch and six inches, and lengths from 20 feet to 600 feet, most commonly approximately 2 inches feet by 300 feet, which will be normally adequate to cover the gaps formed by abutting wallboards. The most common width being 2.0625″ (52.387 mm) width.

The present invention may also be formed into patches that will accommodate most common penetrations in wall assemblies, pipes, wall angles, receptacles, ect. That is, in accordance with the invention, the disclosed embodiment may include many forms, although the majority of use is in the form of an elongated resin impregnated tape. Other such forms may be rectangles, squares, circles, and frames of those shapes, as well as appliqués combined with other materials for use as adjuncts or as accessories in activities associated with the construction industry and general crafts where applicable.

The cost of manufacture of the disclosed tape is only marginally greater than that of conventional paper tape, and well within the price range of the highest quality fiberglass tape. But with the elimination of the initial layer of compound, fewer person-hours are necessary to accomplish the drywall joint task and a great savings emerges.

The present invention is not limited to the precise details of structure described in the specification, for obvious modifications will occur to those skilled in the art to which the invention pertains. And although the present invention has been described in detail and with particularity, it will be appreciated by those skilled in this art that changes and modifications can be made therein without departing from the scope and spirit of the invention.

What is claimed:

1. A fire-resistant wallboard tape for covering elongated joints in wallboards comprising:
a fluid-activated, gummed adhesive;
a fibrous material having a resin-impregnated body, the resin-impregnated body being non-moisture absorbent, the resin-impregnated body remaining relatively non-moisture absorbent during activation of the fluid-activated, gummed adhesive; and
a flame retardant additive, the flame retardant additive allowing the fire-resistant wallboard tape to achieve at least a one-hour fire rating.

2. The fire-resistant wallboard tape of claim 1 whereby activation of the fluid-activated, gummed adhesive occurs by submerging the fire-resistant wallboard tape into a fluid.

3. The fire-resistant wallboard tape of claim 2 whereby the fluid is water.

4. The fire-resistant wallboard tape of claim 1 whereby the fluid-activated, gummed adhesive dries in about 5 to 60 minutes after activation.

5. The fire-resistant wallboard tape of claim 1 whereby the fibrous material has a top surface and a bottom surface.

6. The fire-resistant wallboard tape of claim 5 whereby the fluid-activated, gummed adhesive is applied to a bottom surface of the fibrous material.

7. The fire-resistant wallboard tape of claim 6 whereby the bottom surface of the fibrous material is applied adjacent to and over elongated joints in wallboards.

8. The fire-resistant wallboard tape of claim 1 whereby the fluid-activated, gummed adhesive is a water-soluble, water-activated adhesive.

9. The fire-resistant wallboard tape of claim 1 further comprising:
a color additive.

10. The fire-resistant wallboard tape of claim 1 further comprising:
a surface-sizing agent.

11. The fire-resistant wallboard tape of claim 10 whereby the surface-sizing agent prevents an installed tape from being re-activated.

12. The fire-resistant wallboard tape of claim 1 whereby the fluid-activated, gummed adhesive is activated prior to installation over an elongated joint.

13. The fire-resistant wallboard tape of claim 1 whereby the fluid-activated, gummed adhesive is activated by wetting surfaces adjacent to an elongated joint.

14. The fire-resistant wallboard tape of claim 1 further comprising:
mold and mildew inhibitors.

15. The fire-resistant wallboard tape of claim 14 whereby the mold and mildew inhibitors include a liquid polysiloxane and the liquid polysiloxane is mixed with the fluid-activated, gummed adhesive in a proportion of less than five percent by volume.

16. A method of manufacturing a fire-resistant wallboard tape comprising the steps of:
providing a fluid-activated, gummed adhesive;
providing a fibrous material having a resin-impregnated body, the resin-impregnated body being non-moisture absorbent, the resin-impregnated body remaining relatively non-moisture absorbent during activation of the fluid-activated, gummed adhesive;
providing a flame retardant additive, the flame retardant additive allowing the fire-resistant wallboard tape to achieve at least a one-hour fire rating; and
coating a first side of the fibrous material with the fluid-activated, gummed material and the flame retardant additive.

17. A method of using a fire-resistant wallboard tape to cover elongated joints in wallboards comprising the steps of:
a) providing an elongated length of fire-resistant wallboard tape of width sufficient to overlie the elongated joints, the tape including a resin impregnated fibrous base, a fluid-activated, gummed adhesive and a fire retardant additive;
b) wetting an exposed surface of the fluid-activated, gummed adhesive, said resin impregnated fibrous base remaining relatively non-moisture absorbent during the wetting of the exposed surface of the fluid-activated, gummed adhesive;
c) pressing the exposed surface of the fluid-activated, gummed adhesive into smooth contact with the wallboards to overlie the elongated joints and to adhere the exposed surface of the fluid-activated, gummed adhesive to the wallboards; and
d) allowing the exposed surface of the fluid-activated, gummed adhesive to dry by evaporation of moisture in about less than one hour.
